(19) United States
(12) Patent Application Publication
(10) Pub. No.: US 2020/0201946 A1
(43) Pub. Date: Jun. 25, 2020

(54) ACCURATE AND EFFICIENT MODELING METHOD FOR TERAHERTZ BRANCH WAVEGUIDE DIRECTIONAL COUPLER

(71) Applicant: University of Electronix Science and Technology of China, Chengdu (CN)

(72) Inventors: Bo ZHANG, Chengdu (CN); Zhongqian NIU, Chengdu (CN); Yang LIU, Chengdu (CN); Yinian FENG, Chengdu (CN); Tianchi ZHOU, Chengdu (CN); Yilin YANG, Chengdu (CN); Dongfeng JI, Chengdu (CN); Yiwei WANG, Chengdu (CN); Zhi CHEN, Chengdu (CN); Yaxin ZHANG, Chengdu (CN); Yong FAN, Chengdu (CN)

(21) Appl. No.: 16/451,971

(22) Filed: Jun. 25, 2019

(30) Foreign Application Priority Data
Dec. 25, 2018 (CN) 201811593891.0

(51) Int. Cl. G06F 17/50; G02B 27/00; G02B 6/28; H01P 5/18

(52) U.S. Cl. CPC G06F 17/50; G02B 27/0012; G06F 17/5009; H01P 5/18; G02B 6/28

(57) ABSTRACT

The present invention discloses an accurate and efficient modeling method for the terahertz branch waveguide directional coupler, which uses mode matching method (MMM) to take into account the effects on the coupler field distribution caused by the branch structure discontinuity, combines odd and even mode analysis method to further simplify the derivation process, and finally obtains a simplified and accurate calculation formula of the coupling degree, which the latter produces a new conclusion that when the work frequency of the branch waveguide directional coupler is determined, the coupling degree thereof is determined by the sum of the branch widths. The modeling method of the present invention has the characteristics of simplicity, which can greatly shorten the modeling time and improve the efficiency of the modeling compared with the traditional modeling method. In addition, the modeling method has the characteristics of universality.

### CROSS-REFERENCE TO RELATED APPLICATION

This application claims the benefit under 35 U.S.C. § 119 of Chinese Application No. 201811593891.0, filed Dec. 25, 2018, which hereby incorporated in its entirety.

### FIELD OF THE INVENTION

The present invention relates to the terahertz technical field, and more particularly to an accurate and efficient modeling method for a terahertz branch waveguide directional coupler.

### BACKGROUND OF THE INVENTION

The terahertz wave is recognized by the international academic community as a very important frontier technical field, and is electromagnetic radiation having a wavelength in a range of 3mm-0.03mm (100GHz-10THz), wherein its waveband is between the microwave and the infrared. The terahertz technology has great scientific value and extensive application foreground in object imaging, environmental monitoring, medical diagnosis, radio astronomy, broadband mobile communication and so on.

Since the mid-1990s, governments and military departments such as National Science Foundation, the Space Agency, the Department of Defense, and the National Institutes of Health have continued to provide large financial support for the terahertz scientific research projects and gained fruitful achievements, and Virginia Diode Inc (VDI), NASA Jet Propulsion Laboratory (JPL) and other companies with high reputation in the terahertz technical field have emerged. In Europe, many universities and research institutes have also carried out the research in the terahertz technical field, and the most representative of which includes Rutherford National Laboratory, Cambridge University, University of Leeds, University of Nuremberg, Synchrotron Radiation Center in Berlin, German Nuclear Physics Research Center, etc. In Asia, the enthusiasm for researching terahertz technology has also been increasing, and many universities have conducted research on the terahertz technology. The Japanese government has ranked the terahertz technology as the first of the top ten national fundamental strategic goals, and systematically allocated resources to conduct comprehensive and thorough research. In 2004, the American MIT rated the terahertz technology as one of the top ten technologies capable of changing the future world.

A directional coupler is a four-port passive component for power allocation and is widely used in microwave systems. The directional coupler plays an indispensable role in electronic countermeasures, communication systems, radar systems, and test and measurement instruments. Its main uses comprise power dividing and combining, power range extension, power and spectrum monitoring and the like. In some important microwave measuring instruments such as vector network analyzers and reflectors, the directional coupler also has a wide application. As a main frequency band of the current electronic technology which is explored to solve the problem of electromagnetic wave spectrum crowding in the future, the terahertz wave has received extensive attention in the communication, anti-terrorism detection and astronomical detection, while the directional coupler is an important device in the circuit, thus the research of the directional coupler in the terahertz band has a very high application value.

A branch waveguide coupler is a very common circuit structure capable of realizing power coupling in the terahertz band, which has advantages of matching each port, high isolation, small insertion loss, etc., improves the shortage of the three-port component, and has the characteristics of high power capacity. In the terahertz band, due to the sharp reduction in circuit size, the conventional coupler modeling method in the microwave band is not applicable in the terahertz band. A currently reported modeling method for branch waveguide directional couplers in the terahertz band is based on the methods described in John Reed's papers of “The Multiple Branch Waveguide Coupler” and “A Method of Analysis of Symmetrical Four-port Networks”. Such method ignores the discontinuity caused by the branches. This approximation has little effect on the accuracy of the modeling in the millimeter wave band, but as the frequency further rises to the terahertz band, the error caused by the approximation may increase, thereby affecting the accuracy of the coupler modeling. Furthermore, such method can only design a symmetrical structure coupler, and the design method needs to be combined with the Chebyshev polynomial recursion, having a cumbersome process, an intensive calculation amount and no universality.

### BRIEF SUMMARY OF THE INVENTION

In order to solve the problem that the traditional modeling method for the terahertz band branch line waveguide directional coupler is inaccurate and has a cumbersome design process, the present invention discloses an accurate and efficient modeling method for the terahertz branch waveguide directional coupler, which uses mode matching method (MMM) to take into account the effects on the coupler field distribution caused by the branch structure discontinuity, combines odd and even mode analysis method to further simplify the derivation process, and finally obtains a simplified and accurate calculation formula of the coupling degree, which the latter produces a new conclusion that when the work frequency of the branch waveguide directional coupler is determined, the coupling degree thereof is determined by the sum of the branch widths.

The present invention is realized by the following technical solutions:

An accurate and efficient modeling method for a terahertz branch waveguide directional coupler uses a mode matching method and an odd and even mode analysis method to realize a modeling of the branch waveguide directional coupler.

Preferably, the modeling method specifically comprises:

step 1: performing a structural analysis on the branch waveguide directional coupler;

step 2: using the odd and even mode analysis method to simplify a four-port network into a two-port network structure, and splitting the two-port network structure into several T-type sections; and

step 3: using the mode matching method and the odd and even mode analysis method together to determine network parameters of an entire circuit of the branch waveguide directional coupler, and modeling the branch waveguide directional coupler based on the network parameters of the entire circuit.

Preferably, the step 3 specifically comprises:

step 3.1: using the mode matching method to analyze a structure of each of the several T-type sections to obtain a scattering matrix thereof, and obtaining a cascading matrix of the entire circuit of a five-branch waveguide directional coupler by a network cascading matrix;

step 3.2: obtaining a reflection coefficient and a transmission coefficient in the circuit based on the cascading matrix of the entire circuit of the coupler;

step 3.3: obtaining the scattering matrix of the coupler by the reflection coefficient and transmission coefficient; and

step 3.4: obtaining an accurate calculation formula for a coupling degree of the coupler according to the scattering matrix of the coupler, and realizing the modeling of the branch waveguide directional coupler.

Preferably, the step 3.1 specifically comprises:

step 3.1.1: for an even mode excitation, each of the several T-type sections being equivalent to a two-port network of which a port 3 being shorted; and for an odd mode excitation, each of the several T-type sections being equivalent to a two-port network of which a port 3 being opened;

step 3.1.2: obtaining an admittance matrix of each of the several T-type sections, and converting the admittance matrix of each of the several T-type sections into an ABCD matrix; and

step 3.1.3: obtaining the cascading matrix of the five-branch waveguide directional coupler based on the ABCD matrix of each of the several T-type sections.

Preferably, the step 3.2 specifically comprises:

determining the reflection coefficient and the transmission coefficient in the circuit based on a relationship between the cascading matrix and the reflection coefficient Γ and a relationship between the cascading matrix and the transmission coefficient T, in which:

$${Γ}_{i} = \frac{A + B - C - D}{( A + B + C + D )}$$

$${T}_{i} = \frac{2}{A + B + C + D}$$

wherein i refers to any one of odd mode and even mode.

Preferably, the step 3.3 specifically comprises:

determining an accurate value of the scattering matrix of the coupler based on a relationship between the scattering matrix S and the reflection coefficient Γ and a relationship between the scattering matrix S and the transmission coefficient T, in which:

S₁₁=½Γₑ+½Γₒ

S₂₁=½Γₑ+½Γₒ

S₃₁=½Γₑ−½Γₒ

S₄₁=½Γₑ−½Γₒ

wherein e refers to an even mode, and o refers to an odd mode.

Preferably, the step 3.4 specifically comprises:

step 3.4.1: simplifying the scattering matrix of the directional coupler to obtain the calculation formula of the coupling degree of the coupler as follows:

$${S}_{31} = {[ \frac{( {h}_{1} + {h}_{2} + {h}_{3} + ⋯ + {h}_{n} )}{λ} ]}^{k} and ( {h}_{1} + {h}_{2} + {h}_{3} + ⋯ + {h}_{n} ) < λ$$

wherein S₃₁ is a coupling refers to the coupling degree of the coupler, n refers to the amount of waveguide branches of the coupler and n≥3, λ refers to a waveguide wavelength, k is a frequency-independent constant, and hᵢ refers to the width of a i-th waveguide branch of the waveguide branches of the coupler, wherein 1=1,2, . . . , n, wherein n refers to the amount of the waveguide branches of the coupler and n≥3; and

step 3.4.2: based on the calculation formula obtained in the step 3.4.1, determining a width of each of the waveguide branches of the coupler according to a required coupling degree of the coupler.

Preferably, the step 1 specifically comprises:

step 1.1: firstly determining a spacing between a port 1 and a port 4 of the branch waveguide directional coupler, and determining that a spacing between two of the waveguide branches is λ/4; and

step 1.2: sequentially setting the width of a i-th waveguide branch of the waveguide branches of the coupler to be hᵢ, wherein i=1,2, . . . , n, wherein n refers to the amount of the waveguide branches of the coupler and n≥3.

Preferably, the step 2 specifically comprises:

step 2.1: using the odd and even mode analysis method to simplify an analysis of a four-port circuit of the coupler into an analysis of a two-port circuit; and

step 2.2: using a network cascading method to split the two-port circuit into several T-type sections, and simplifying an analysis of the entire circuit into an analysis of a circuit of each of the several T-type sections.

The present invention has following advantages and beneficial effects:

The modeling method provided in the present invention has the characteristics of simplicity, which can greatly shorten the modeling time and improve the efficiency of the modeling compared with the traditional modeling method. In addition, the modeling method is applicable to any coupler design having any number of branches (the number of the branches is three or more) and any coupling degree, thus compared with the traditional modeling method that has many limitations, the modeling method of the present invention has the characteristics of universality.

### BRIEF DESCRIPTION OF THE DRAWINGS

The drawings described herein are intended to provide a further understanding of the examples of the present invention and form a part of the application, but does not constitute a limitation of the examples of the present invention. In the drawings:

FIG. 1 is a flowchart of a modeling method for a terahertz branch waveguide directional coupler of the present invention;

FIG. 2 is a schematic structural diagram of an existing five-branch waveguide directional coupler used in the Example 1 of the present invention;

FIG. 3 is a structural analysis chart of the existing five-branch waveguide directional coupler used in the Example 1 of the present invention;

FIG. 4 is a schematic diagram showing the simplification of a four-port network structure of the coupler into a two-port network structure in the Example 1 of the present invention;

FIG. 5 is a schematic diagram showing the equivalent network structure of a T-type section under an even mode excitation in the Example 1 of the present invention;

FIG. 6 is a schematic diagram showing the equivalent network structure of a T-type section under an odd mode excitation in the Example 1 of the present invention;

FIG. 7 shows simulation results for a three-branch waveguide directional coupler designed in the Example 2 of the present invention;

FIG. 8 shows simulation results for a four-branch waveguide directional coupler designed in the Example 2 of the present invention;

FIG. 9 shows simulation results for a five-branch waveguide directional coupler designed in the Example 2 of the present invention;

FIG. 10 shows simulation results for a four-branch asymmetric waveguide directional coupler designed in the Example 2 of the present invention; and

FIG. 11 shows simulation results for couplers with different coupling degrees designed in the Example 2 of the present invention.

### DETAILED DESCRIPTION OF THE PREFERRED EMBODIMENTS

In order to clarify the purpose, solution and advantages for the present invention, with reference to the accompanying examples and drawings, the present invention is further described in detail, the embodiments and the illustrations thereof is merely illustrative of the invention and are not intended to limit the invention.

### EXAMPLE 1

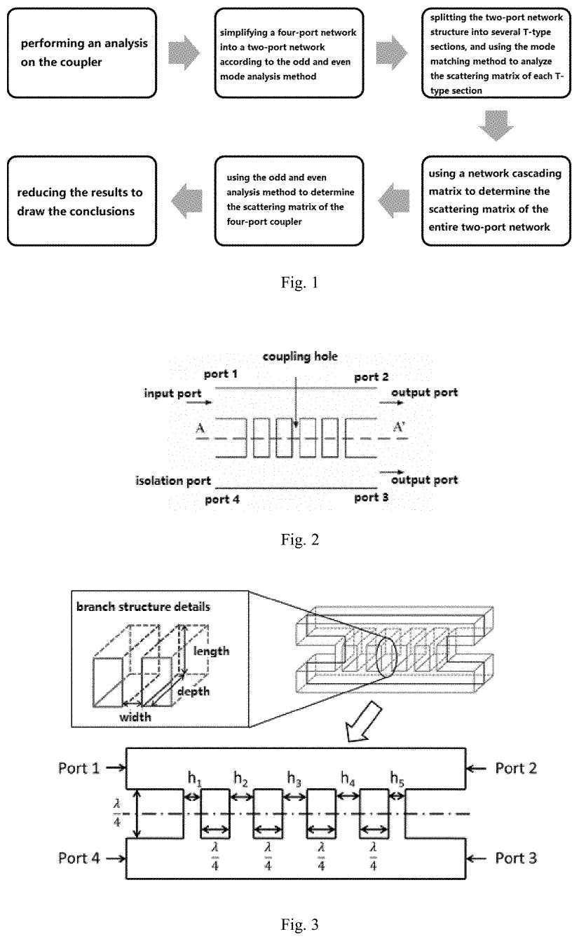

This example provides an accurate and efficient modeling method for a terahertz branch waveguide directional coupler, which uses a mode matching method (MMM) to take into account the effects on the coupler field distribution caused by the branch structure discontinuity, combines odd and even mode analysis method to further simplify the derivation process, and finally obtains a simplified and accurate calculation formula of the coupling degree, achieving the modeling of the terahertz branch waveguide directional coupler. As shown in FIG. 1, the detailed modeling process is as follows.

1. The branch waveguide directional coupler is structurally analyzed.

A branched rectangular waveguide bridge is an extremely useful power dividing and combining structure, and is a commonly used orthogonal hybrid bridge capable of achieving tight coupling in a wide frequency band. The traditional five-branch waveguide directional coupler as shown in FIG. 2 mainly comprises an input port (port 1), a through port (port 2), a coupling port (port 3) and an isolated port (port 4), wherein the through port and the coupling port serve as output ports, and their output signals have a phase difference of 90°. The signals input from the port 1 are each split into two signals which are respectively transmitted to the port 2 and the port 3, and the port 4 is the isolated port requiring to be connected to a matched load.

In this example, the five-branched waveguide directional coupler is structurally analyzed and modeled. For the typical five-branch waveguide coupler, the spacing between the port 1 and the port 4 as well as the spacing between two adjacent waveguide branches are firstly determined as λ/4, thereafter the widths of the branches are respectively set as h1 to h5, and the width, length and depth of each branch are defined as shown in FIG. 3.

2. The odd and even mode analysis method is used to simplify a four-port network into a two-port network structure.

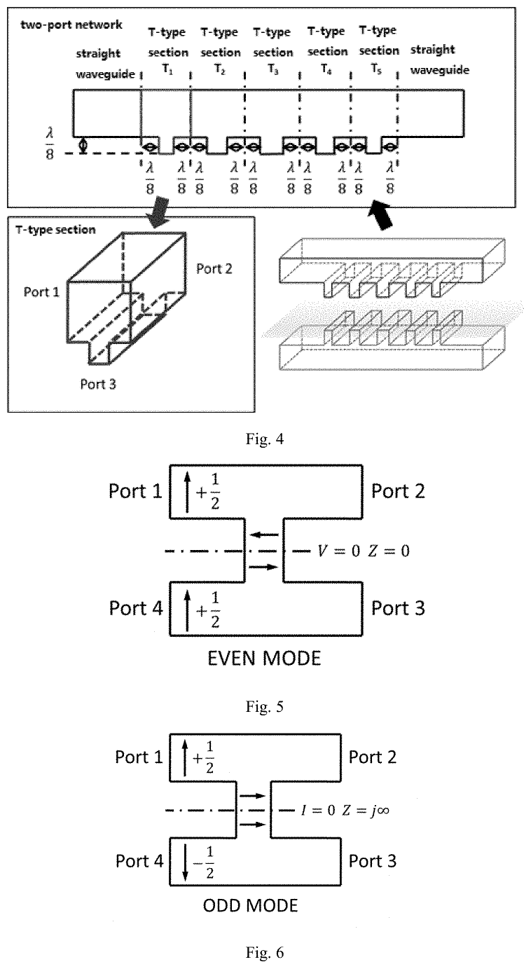

The odd and even mode analysis is used, according to the symmetry and reciprocity of the coupler, to simplify an analysis of a four-port circuit into a two-port circuit, and the two-port network structure is split into several T-type sections, which is shown in FIG. 4.

3. The mode matching method is used to analyze a scattering matrix for each of the several T-type sections; and a network cascading matrix is used to determine the scattering matrix of the entire two-port network. The specific progress is as follows:

The mode matching method is used to analyze the scattering matrix of each of the several T-type sections; and the mode matching method is a full-wave analysis method based on the generalized transmission line theory and the field theory. At present, the mode matching method has been developed to a strict field analysis stage, which has advantages of fast calculation speed and high solution precision.

As shown in FIG. 5, for the even excitation, if two signals having the same amplitude and direction respectively enter the port 1 and the port 4, the voltage on the symmetry plane of the coupler is 0, that is to say the impedance on this symmetry plane is 0, which is equivalent to an ideal electric wall.

Then each of the several T-type sections is equivalent to a two-port network in FIG. 5 where the port 3 is shorted. This two-port network, according to the Y matrix formula, has:

$$[ \begin{matrix}{I}_{12} \\ {I}_{2}\end{matrix} ] = {[ \begin{matrix}{Y}_{11} & {Y}_{12} \\ {Y}_{21} & {Y}_{22}\end{matrix} ]}_{o} [ \begin{matrix}{U}_{1} \\ {U}_{2}\end{matrix} ]$$

wherein I₁=Y₁₁ U₁|_{U}_{₂}₌₀, and Y₁₁ is an input admittance matrix of the port 1 when the port 2 is shorted;

wherein I₂=Y₂₂ U₂|_{U}_{₁}₌₀, and Y₂₂ is an input admittance matrix of the port 2 when the port 1 is shorted;

wherein I₂=Y₂₁ U₁|_{U}_{₂}₌₀, and Y₂₁ is a mutual admittance matrix between the port 1 and the port 2 when the port 2 is shorted; and

wherein I₁=Y₁₂ U₂|_{U}_{₁}₌₀, and Y₂₂ is a mutual admittance matrix between the port 1 and the port 2 when the port 1 is shorted.

3.1 Solution of the input admittance matrix [Yᵢᵢ].

[Yᵢᵢ] refers to the input admittance matrix of port i when the other ports are shorted. The [Yᵢᵢ] matrix of the T-type section can be equivalent to the transmission line of which the terminal is shorted, thus according to the transmission line equation, having:

[Uᵢ][2Uᵢⱼ⁺ sin βᵢⱼz′], [Iᵢ]=[2Y₀ⱼⁱUᵢⱼ⁺ cos βᵢⱼz′], [Yᵢᵢ]=−jdiag[Y₀ⱼⁱ cot βᵢⱼz′]

wherein Y₀ⱼⁱ refers to a characteristic admittance as signals enter the port i while other ports are shorted; Uᵢⱼ⁺ refers to the incident voltage in mode j as signals enter port i while other ports are shorted; and βᵢⱼ refers to a transmission coefficient in the mode j when signals enter the port i while other ports are shorted.

For the studied T-type section, has:

[Y₁₁]=−jdiag[Y₀ⱼ¹ cot β₁ⱼz′], z′=λ/8, [Y₂₂]=−j diag[Y₀ⱼ² cot β₂ⱼz′], z′=λ/8

In order to simplify the calculation, Yₒⱼ is set to be 1, and due to the symmetry of the port 1 and the port 2, the transmission coefficient of each mode has a relationship of β₁ⱼ=β₂ⱼ=βⱼ, then obtaining:

[Y₁₁]=−jdiag[cot βᵢλ/8,]Y₂₂=−jdiag[cot βᵢλ/8]

3.2 Solution of mutual admittance matrix[Yᵢⱼ].

According to the reciprocity theory, the T-type section has[Y₂₁]=[Y₁₂]^{T}, wherein Y₂₁ refers to a mutual admittance matrix between the port 1 and the port 2 as the port 2 is shorted. Then according to the generalized transmission line theory, the input voltage is[U₁]=[j2U₁ⱼ⁺ sin β₁ⱼc], and the terminal current [I₁]|(z′=0)=[2Y₀ⱼ¹U₁ⱼ⁺], while the current incident direction of the port 3 is the −z direction, thus [I₃]=−[I₁]|(z′=0). Therefore [Y₂₁]=jdiag[Y₀ⱼ¹ csc β₁ⱼc], where Yₒⱼ=1, and β₁ⱼ=β₂ⱼ=βⱼ.

More generally, for the T-type section T1,c=h₁, then [Y₂₁]=[Y₁₂]=jdiag[csc βⱼh₁].

In this way, the admittance matrix [Y]ₑ of the T-type section under the even mode excitation is obtained.

In order to ensure the accuracy of the model matching method, the amount of the modes is usually more than 12, thus the admittance matrix [Y]ₑ of the T-type section can be extended to:

$${[ Y ]}_{e} = {[ \begin{matrix}{Y}_{11} & {Y}_{12} \\ {Y}_{21} & {Y}_{22}\end{matrix} ]}_{e} = j [ \begin{matrix}- cot {β}_{1} λ \text{/} 8 & 0 & & & csc {β}_{1} {h}_{1} & 0 & & \\ & & & ⋮ & & & ⋮ & \\ 0 & - cot {β}_{2} λ \text{/} 8 & & & 0 & csc {β}_{2} {h}_{1} & & \\ & & ⋱ & 0 & & & ⋱ & 0 \\ & ⋮ & & & & ⋮ & & \\ & & 0 & - cot {β}_{12} \text{/} 8 & & & 0 & csc {β}_{12} {h}_{1} \\ csc {β}_{1} {h}_{1} & 0 & & & - cot {β}_{1} λ \text{/} 8 & 0 & & \\ & & ⋮ & & & & & ⋮ \\ 0 & csc {β}_{2} {h}_{1} & & & 0 & - cot {β}_{2} λ \text{/} 8 & & \\ & & ⋱ & - & & & ⋱ & 0 \\ & ⋮ & & & & ⋮ & & \\ & & 0 & csc {β}_{12} {h}_{1} & & & 0 & - cot {β}_{12} λ \text{/} 8\end{matrix} ]$$

As shown in FIG. 6, for the odd mode excitation, if two signals having the same amplitude and opposite directions respectively enter the port 1 and the port 4, the current on the symmetry plane of the coupler is 0, that is to say the impedance on the symmetry plane is infinite, which is equivalent to an ideal magnetic wall.

Then each of the several T-type sections is equivalent to a two-port network in FIG. 6 where the port 3 is opened.

Similarly, the admittance matrix [Y]ₒ of the T-type section under the odd mode excitation is obtained as follows:

$${[ Y ]}_{o} = {[ \begin{matrix}{Y}_{11} & {Y}_{12} \\ {Y}_{21} & {Y}_{22}\end{matrix} ]}_{o} = j [ \begin{matrix}tan {β}_{1} λ \text{/} 8 & 0 & & & - sec {β}_{1} {h}_{1} & 0 & & \\ & & & ⋮ & & & ⋮ & \\ 0 & tan {β}_{2} λ \text{/} 8 & & & 0 & - sec {β}_{2} {h}_{1} & & \\ & & ⋱ & 0 & & & ⋱ & 0 \\ & ⋮ & & & & ⋮ & & \\ & & 0 & tan {β}_{12} \text{/} 8 & & & 0 & - sec {β}_{12} {h}_{1} \\ - sec {β}_{1} {h}_{1} & 0 & & & tan {β}_{1} λ \text{/} 8 & 0 & & \\ & & ⋮ & & & & & ⋮ \\ 0 & - sec {β}_{2} {h}_{1} & & & 0 & tan {β}_{2} λ \text{/} 8 & & \\ & & ⋱ & - & & & ⋱ & 0 \\ & ⋮ & & & & ⋮ & & \\ & & 0 & - sec {β}_{12} {h}_{1} & & & 0 & tan {β}_{12} λ \text{/} 8\end{matrix} ]$$

In order to facilitate the analysis of the scattering matrix of the entire circuit network, the admittance matrix [Y] of the T-type section T1 is converted into a cascading matrix according to the formulas. In this example, an ABCD matrix is used to describe the cascading network, which uses the output of the last level as the input of the current level. Namely in this example, the admittance matrix [Y] of the T-type section T1 is converted into the ABCD matrix:

$${[ \begin{matrix}A & B \\ C & D\end{matrix} ]}_{{T}_{1}^{i}} = {[ \begin{matrix}- {Y}_{22} \text{/} {Y}_{21} & - 1 \text{/} {Y}_{21} \\ ( {Y}_{12} {Y}_{21} - {Y}_{11} {Y}_{22} ) \text{/} {Y}_{21} & - {Y}_{11} \text{/} {Y}_{21}\end{matrix} ]}_{i}$$

wherein i refers to the any one of the odd mode and the even mode.

Then the cascading matrix of the five-branch directional coupler can be obtained as follow:

$${[ \begin{matrix}A & B \\ C & D\end{matrix} ]}_{i} = {{{{{[ \begin{matrix}A & B \\ C & D\end{matrix} ]}_{{T}_{1}^{i}} [ \begin{matrix}A & B \\ C & D\end{matrix} ]}_{{T}_{2}^{i}} [ \begin{matrix}A & B \\ C & D\end{matrix} ]}_{{T}_{3}^{i}} [ \begin{matrix}A & B \\ C & D\end{matrix} ]}_{{T}_{4}^{i}} [ \begin{matrix}A & B \\ C & D\end{matrix} ]}_{{T}_{5}^{i}}$$

Next, the reflection coefficient and the transmission coefficient in the circuit can be obtained according to a relationship between the cascading matrix and the reflection coefficient Γ, and a relationship between the cascading matrix and the transmission coefficient T.

$${Γ}_{i} = \frac{A + B - C - D}{( A + B + C + D )}$$

$${T}_{i} = \frac{2}{A + B + C + D}$$

Finally, according to the relationship between the scattering matrix S and reflection coefficient Γ as well as the relationship between the scattering matrix S and transmission coefficient T:

S₁₁=½Γₑ+½Γₒ

S₂₁=½Tₑ+½Tₒ

S₃₁=½Tₑ−½Tₒ

S₄₁=½Γₑ−½Γₒ

wherein e refers to the even mode, and o refers to the odd mode. The accurate value of the scattering matrix of the coupler can be obtained.

When in use, the coupler is in the dominant transmission mode, while the other modes are cut off by the waveguide and cannot transmit. Therefore, the coupling degree S₃₁ of the five-branch waveguide directional coupler is obtained as follows:

$${S}_{31} = {[ \frac{( {h}_{1} + {h}_{2} + {h}_{3} + ⋯ + {h}_{n} )}{λ} ]}^{k}$$

wherein k is a constant independent of the frequency (about 1.7), λ is the wave length of the waveguide, and the sum of the width of each branch (h₁+h₂+h₃+h₄+h₅)<λ.

4. Based on the coupling degree of the five-branch waveguide directional coupler obtained above, the calculation formula of the coupling degree of the n-branch (n≥3) waveguide directional coupler is obtained as follows:

$${S}_{31} = {[ \frac{( {h}_{1} + {h}_{2} + {h}_{3} + ⋯ + {h}_{n} )}{λ} ]}^{k}$$

At the same time, (h₁+h₂+h₃+ . . . +hₙ)<λ is considered, wherein n refers to the amount of waveguide branches of the coupler and n≥3, λ refers to a waveguide wavelength, and k is a frequency-independent constant (about 1.7). That is to say that the modeling of the branch waveguide coupler can be realized by selecting the width of each branch according to the desired coupling degree of the coupler, as well as meeting the requirement of the formulas. It can be learnt from the formula that when the work frequency is determined (λ is a determined value), the coupling degree of the branch waveguide coupler is determined by the sum of widths of all the branches.

It can be seen that the formulas obtained in this example has the characteristics of simplicity, capable of greatly shortening the modeling time and improving the modeling efficiency compared with the traditional modeling method. Moreover, the modeling method of this example is applicable to any coupler design having any number of branches (the number of the branches is three or more) and any coupling degree, and has the characteristics of universality.

### EXAMPLE 2

Based on the accurate and efficient modeling method for the terahertz branch waveguide directional coupler provided in the Example 1, the Example 2 further performs the simulation verification of the branch waveguide directional coupler. The simulation tool uses Ansoft's HFSS(High Frequency Structure Simulator) software. After the calculation, the k in the formula is about 1.7. When the work frequency is 400 GHz and the coupling degree is 3 dB (equally divided power), the sum of the widths of all branches is 0.5 mm. In order to comprehensively verify the accuracy and universality of the modeling of the present invention, this example designs several couplers having different structures and coupling degrees.

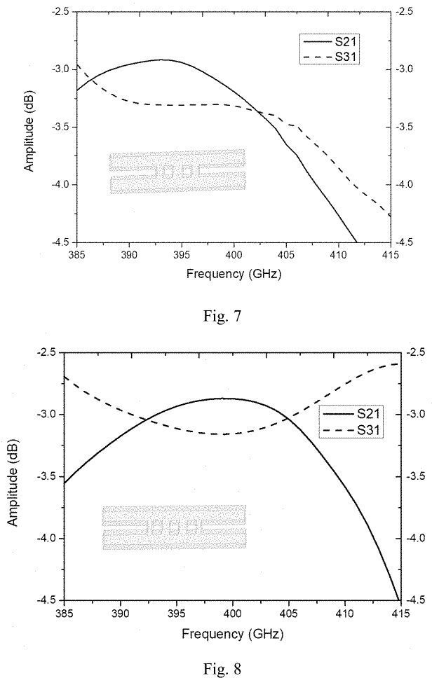

The structure and simulation results of the three-branch waveguide coupler are shown in FIG. 7, and the widths of h₁, h₂ and h₃ are respectively 0.15 mm, 0.2 mm and 0.15 mm.

The structure and simulation results of the four-branch waveguide coupler are shown in FIG. 8, and the widths of h₁, h₂, h₃ and h₄ are respectively 0.1 mm, 0.15 mm, 0.15 mm and 0.1 mm.

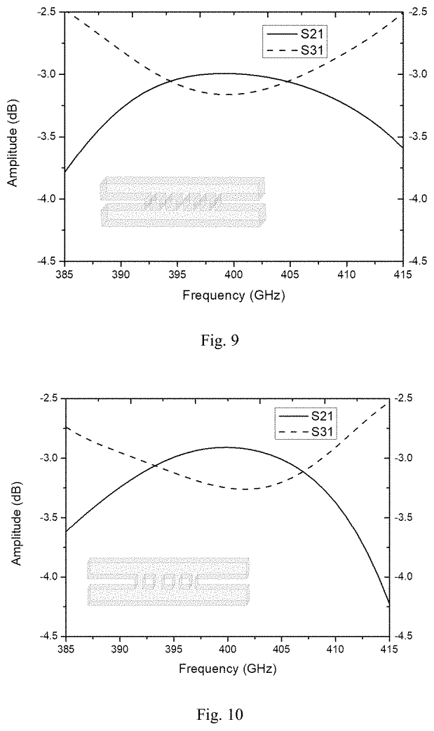

The structure and simulation results of the five-branch waveguide coupler are shown in FIG. 9, and the widths of h₁, h₂, h₃, h₄ and h₅ are respectively 0.08 mm, 0.1 mm, 0.14 mm, 0.1 mm and 0.08 mm.

In addition, this example also designs a four-branch directional coupler with an asymmetric structure whose structure and simulation results are shown in FIG. 10, and the widths of h₁ to h₄ are respectively 0.14 mm, 0.16 mm, 0.12 mm and 0.08 mm.

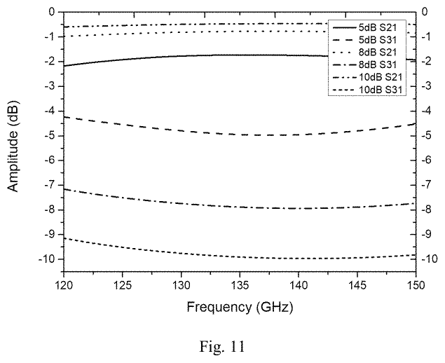

In order to further verify the universality of such modeling method, the simulation verifications of the couplers with different coupling degrees are performed. According to the above formulas, at the frequency of 400 GHz, the sum values for of branch widths of couplers having coupling degrees of 5 dB, 8 dB and 10 dB are respectively 0.37 mm, 0.25 mm and 0.19 mm, and the simulation results are shown in FIG. 11.

Therefore, the modeling method proposed in the Example 1 is applicable to the coupler designs of any number of branches (the number of branches is three or more) and any coupling degree.

The specific examples described above further explain the purposes, technical solutions and beneficial effects of the present invention. It is to be understood that the foregoing is only illustrative of the examples of the present invention, and is not intended to limit the scope of the present invention. Any modifications, equivalents, and improvements made within the spirit and scope of the present invention should be included in the scope of protection of the present invention.

What is claimed is:

1. An accurate and efficient modeling method for a terahertz branch waveguide directional coupler, using a mode matching method and an odd and even mode analysis method to realize a modeling of the branch waveguide directional coupler.

2. The modeling method of claim 1, comprising following steps:
step 1: performing a structural analysis on the branch waveguide directional coupler;
step 2: using the odd and even mode analysis method to simplify a four-port network into a two-port network structure, and splitting the two-port network structure into several T-type sections; and
step 3: using the mode matching method and the odd and even mode analysis method together to determine network parameters of an entire circuit of the branch waveguide directional coupler, and modeling the branch waveguide directional coupler based on the network parameters of the entire circuit.

3. The modeling method of claim 2, wherein the step 3 comprises following steps:
step 3.1: using the mode matching method to analyze a structure of each of the several T-type sections to obtain a scattering matrix thereof, and obtaining a cascading matrix of the entire circuit of a five-branch waveguide directional coupler by a network cascading matrix;
step 3.2: obtaining a reflection coefficient and a transmission coefficient in the circuit based on the cascading matrix of the entire circuit of the coupler;
step 3.3: obtaining the scattering matrix of the coupler by the reflection coefficient and transmission coefficient; and
step 3.4: obtaining an accurate calculation formula for a coupling degree of the coupler according to the scattering matrix of the coupler, and realizing the modeling of the branch waveguide directional coupler.

4. The modeling method of claim 3, wherein the step 3.1 comprises following steps:
step 3.1.1: for an even mode excitation, each of the several T-type sections being equivalent to a two-port network of which a port 3 being shorted; and for an odd mode excitation, each of the several T-type sections being equivalent to a two-port network of which a port 3 being opened;
step 3.1.2: obtaining an admittance matrix of each of the several T-type sections, and converting the admittance matrix of each of the several T-type sections into an ABCD matrix; and
step 3.1.3: obtaining the cascading matrix of the five-branch waveguide directional coupler based on the ABCD matrix of each of the several T-type sections.

5. The modeling method of claim 4, wherein the step 3.2 comprises:
determining the reflection coefficient and the transmission coefficient in the circuit based on a relationship between the cascading matrix and the reflection coefficient Γ and a relationship between the cascading matrix and the transmission coefficient T, in which:
$${Γ}_{i} = \frac{A + B - C - D}{( A + B + C + D )}$$
$${T}_{i} = \frac{2}{A + B + C + D}$$
wherein i refers to any one of odd mode and even mode.

6. The modeling method of claim 5, wherein the step 3.3 comprises:
determining an accurate value of the scattering matrix of the coupler based on a relationship between the scattering matrix S and the reflection coefficient Γ and a relationship between the scattering matrix S and the transmission coefficient T, in which:
S₁₁=½Γₑ+½Γₒ
S₂₁=½Tₑ+½Tₒ
S₃₁=½Tₑ−½Tₒ
S₄₁=½Γₑ−½Γₒ
wherein e refers to an even mode, and o refers to an odd mode.

7. The modeling method of claim 6, wherein the step 3.4 comprises following steps:
step 3.4.1: simplifying the scattering matrix of the directional coupler to obtain the calculation formula of the coupling degree of the coupler as follows:
$${S}_{31} = {[ \frac{( {h}_{1} + {h}_{2} + {h}_{3} + ⋯ + {h}_{n} )}{λ} ]}^{k} and ( {h}_{1} + {h}_{2} + {h}_{3} + ⋯ + {h}_{n} ) < λ$$
wherein S₃₁ refers to the coupling degree of the coupler, n refers to the amount of waveguide branches of the coupler and n≥3 , λ refers to a waveguide wavelength, k is a frequency-independent constant, and hᵢ refers to the width of a i-th waveguide branch of the waveguide branches of the coupler to be hᵢ, wherein i=1,2, . . . , n, wherein n refers to the amount of the waveguide branches of the coupler and n≥3; and
step 3.4.2: based on the calculation formula obtained in the step 3.4.1, determining a width of each of the waveguide branches of the coupler according to a required coupling degree of the coupler.

8. The modeling method of claim 2, wherein the step 1 comprises following steps:
step 1.1: firstly determining a spacing between a port 1 and a port 4 of the branch waveguide directional coupler, and determining that a spacing between two of the waveguide branches is λ/4; and
step 1.2: sequentially setting the width of a i-th waveguide branch of the waveguide branches of the coupler to be hᵢ, wherein i=1,2, . . . , n, wherein n refers to the amount of the waveguide branches of the coupler and n≥3.

9. The modeling method of claim 2, wherein the step 2 comprises following steps:
step 2.1: using the odd and even mode analysis method to simplify an analysis of a four-port circuit of the coupler into an analysis of a two-port circuit; and
step 2.2: using a network cascading method to split the two-port circuit into several T-type sections, and simplifying an analysis of the entire circuit into an analysis of a circuit of each of the several T-type sections.
